(19) United States
(12) Patent Application Publication
(10) Pub. No.: US 2015/0143946 A1
(43) Pub. Date: May 28, 2015

(54) LOCKING DEVICE FOR LOCKING A MOVABLE COMPONENT

(71) Applicant: TAKATA AG, Aschaffenburg (DE)

(72) Inventor: Laszlo Mitre, Berlin (DE)

(73) Assignee: TAKATA AG, Aschaffenburg (DE)

(21) Appl. No.: 14/408,101

(22) PCT Filed: Jun. 15, 2013
(86) PCT No.: PCT/EP2013/062253

§ 371 Date: Dec. 15, 2014

(30) Foreign Application Priority Data
Jun. 15, 2012 (DE) 10 2012 210 122.5
Oct. 25, 2012 (DE) 10 2012 219 549.1

(51) Int. Cl. B62D 5/00; B62D 5/04; G05G 5/00

(52) U.S. Cl. CPC B62D 5/008; G05G 5/005; B62D 5/0454
USPC 74/527

(57) ABSTRACT

The invention relates to a locking device for locking a movable component, in particular a superposition drive, comprising a locking element which in a locking position is formed to cooperate with the movable component. The locking element includes a damping mechanism which during the movement of the locking element into the locking position attenuates a mechanical contact of the locking element with the movable component. The damping mechanism comprises an elastically mounted contact element movable relative to the locking element, which is arranged such that during the movement of the locking element into the locking position it gets in contact with the movable component.

The invention relates to a locking device for locking a movable component, in particular a superposition drive of a steering wheel, according to claim 1.

In operation of a locking device of a superposition drive unwanted noise can be generated, in particular when a locking element of the locking device is moved into a locking or a release position (i.e. into one of its end positions), so that for locking a movable component of the superposition drive (in particular in the form of a rotating drive of the superposition drive) it can mechanically be brought in engagement with the same or the rotating drive can be released. The development of noise can be caused both by the locking element reciprocated between the locking position and the release position and by components which drive the locking element. What can be particularly disturbing is noise in the direct hearing range of a person (in its direct vicinity), as it can be produced for example in a superposition drive arranged in a steering wheel of a motor vehicle. The problem of the generation of noise does of course not only exist during locking of a superposition drive, but it generally arises during locking of a movable component, e.g. also during locking of a linearly moving component.

From DE 10 2010 037 384 A1 there is known a locking device for a superposition steering system with an electromagnetic actuator. The latter drives a locking pin serving as locking element. To avoid a direct mechanical contact between the locking pin and other components of the actuator, elastic O-rings are provided in the end positions of the locking pin. In such arrangement it is disadvantageous that the O-rings merely provide a small deformation path, which imposes certain limits on a design of the course of force during braking of the locking element. The use of air or oil dampers, which furthermore is proposed in the above-mentioned document, is expensive. The space requirement also can be high, which especially in the case of superposition drives arranged in the steering wheel can lead to installation space problems. In addition, what is reduced merely is the development of noise during the movement of the actuator parts.

It is the object underlying the invention to provide a locking device for locking a movable component with as little operating noise as possible.

This object is solved by providing a locking device with the features of claim 1. Developments of the invention are indicated in the dependent claims.

Accordingly, there is provided a locking device for locking a movable component, in particular a superposition drive (in particular for a steering wheel), comprising
a locking element which in a locking position is formed to cooperate with the movable component, wherein
the locking element includes a damping mechanism which during the movement of the locking element into the locking position attenuates a mechanical contact of the locking element with the movable component, and wherein
the damping mechanism comprises an elastically mounted contact element movable relative to the locking element, which is arranged such that during the movement of the locking element into the locking position it gets in contact with the movable component.

The locking device for example serves to lock a superposition drive of a superposition steering system of a vehicle by mechanical action, so that e.g. in the case of a malfunction of the superposition drive an introduction of a steering angle into the steering shaft by the superposition drive is prevented. A possible configuration of the superposition drive and its attachment to the steering wheel and with the steering shaft are described e.g. in WO 2010/115707 A1, to which reference in so far is made expressly.

The locking element in particular is an oblong element which in the mounted condition and in its locking position cooperates with a movable component in the form of a rotatable element (e.g. in the form of a locking disk) of the superposition drive, wherein the locking disk is non-rotatably coupled with a drive worm (in particular with a free end of the drive worm protruding out of the housing of the superposition drive). In particular, the locking element can be reciprocated between the locking position and a release position, in which it does not cooperate with the movable component.

Along its outer circumference, for example, the locking disk includes cutouts into which a (first) free end of the locking element reaching out of the housing of the locking device engages and in particular chiefly positively locks the locking disk, so that the drive worm coupled with the locking disk also is blocked. The release position in particular is a further end position of the locking element, in which the locking element has its greatest distance to the movable component to be locked. In connection with the configuration of the locking element and a device for moving the locking element reference is made to WO 2012/120079, to which reference in so far is made expressly.

The use of the locking device according to the invention, however, is not limited to the locking (i.e. a positional fixation) of a superposition drive. Rather, the locking device can serve for locking a basically arbitrary movable component or a movable assembly, e.g. for locking a linearly moving component.

The fact that the contact element is “elastically mounted” in particular means that in the case of a (mechanical) contact with the movable component to be locked, the contact element is moved relative to the locking element from a starting position, and on removal of the contact element, for example by moving the locking element from the locking position into the release position, from the movable component has the tendency to again return into the starting position. Via the elastically mounted contact element a force in particular is introduced into the locking element against the direction of movement (locking direction) of the same, so that the locking element is braked and as a result impinges on the movable component with reduced speed. In particular, the contact element is formed and arranged such that during a movement of the locking element into the locking position it gets in contact with the movable component before the locking element.

According to one aspect of the invention, the locking element includes a cavity in which the contact element is sectionally arranged. Thus, the locking element is at least partly formed sleeve-shaped. It is conceivable that the cavity only extends over a part of the length of the locking element, e.g. along a portion of the locking element (facing the movable component), while another portion (facing away from the movable component in operation of the locking device) is formed e.g. in a continuous (solid) fashion. In an end facing the movable component, the locking element also can have an opening towards the cavity, from which the contact element protrudes. The opening in particular is defined by a portion of an end face of the locking element, wherein during the movement of the locking element into the locking position the contact element gets in contact with the movable component before the end face of the locking element.

The damping mechanism in particular includes an elastic damping element arranged in the cavity, via which the contact element is elastically movably mounted. The damping element is arranged e.g. on a side of the contact element facing away from the opening of the locking element. During the movement of the locking element into the locking position, the contact element therefore is pressed into the cavity of the locking element in particular against the elastic effect of the damping element due to the contact with the movable element to be locked, for example until the end face of the locking element comes to rest against the movable element.

The elastic damping element for example includes an elastic material (e.g. an elastomer) or it is formed of an elastic material. The damping element e.g. is a molded part. It is, however, also possible that the damping element is formed as spring (e.g. in the form of a spiral or torsion spring).

In addition, it is conceivable that the contact element and the damping element are separate parts, i.e. parts which were manufactured separately, but which can be connected with each other via suitable fastening means. For example, the contact element and the damping element are made of different materials, but are firmly connected with each other (e.g. by means of bonding or vulcanizing), so that they form one part. It is, however, not absolutely necessary that the contact element and the damping element are connected with each other. It is also possible that there is no connection via fastening means, but the elements merely rest against each other. It is also conceivable that the contact element is formed of an other material than the damping element. For example, the contact element is formed of a metal (e.g. steel) or an other (in particular harder) plastic material than the damping element. It is also possible that the contact element and the damping element are formed integrally with each other.

According to another development of the invention, the contact element however is formed integrally with the damping element, so that the contact and the damping element are made of the same material. For example, one molded part (in particular molded of an elastomer) forms both the damping element and the contact element. In particular one portion of this molded part, which forms the contact element, protrudes from the above-mentioned opening of the locking element.

It is also possible that the diameter of the cavity of the locking element is reduced towards the opening formed in its end. In particular, the opening has a diameter which is smaller than the largest diameter of the contact element, so that moving the contact element out of the opening is prevented. In addition, under the influence of the elastic damping element the contact element can be biased against an inside (facing the cavity) of the end of the locking element facing the movable component (e.g. against the edge of the opening), so that the contact element is held in the opening. Upon contact with the movable component, the contact element in particular is pressed into the cavity, as mentioned above, so that it is detached from the inside of the end of the locking element. In particular, the direct contact between the contact element and the locking element thereby is interrupted, and thus the transmission of an impact sound produced upon impingement of the contact element on the movable component as structure-borne sound to the locking element is prevented or at least disturbed.

The contact element for example has a curved contact surface via which it comes to rest against the movable component. It is conceivable that the contact element is formed in the form of a rotational body, in particular a ball, wherein a portion of the surface of the rotational body shapes the curved contact surface. However, the invention is of course not limited to a particular geometry of the contact element. In principle, any geometries are conceivable, and the contact element for example also can have a conical or cylindrical shape.

The invention also relates to a superposition drive (in particular for a steering wheel) of a motor vehicle with a locking device according to the invention.

The invention will subsequently be explained in detail by means of exemplary embodiments with reference to the Figures, in which:

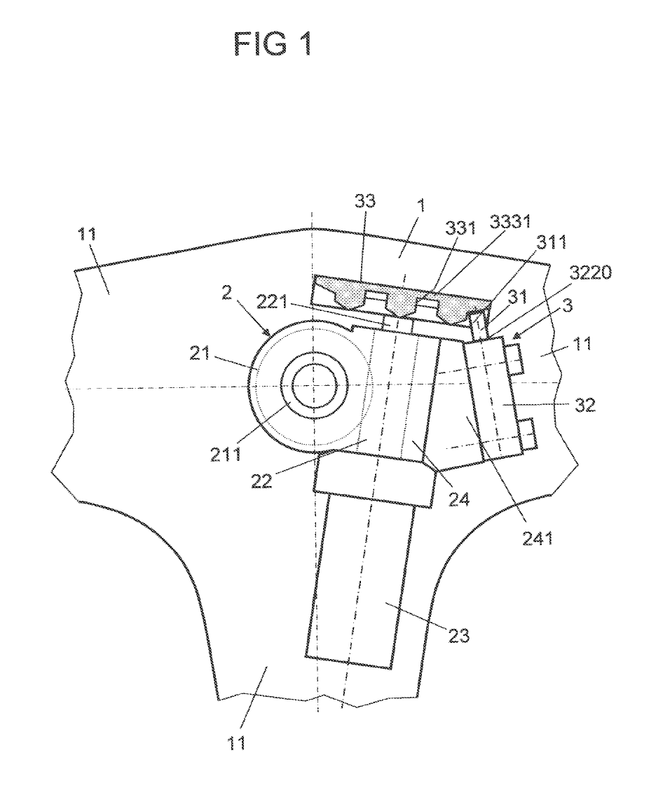

FIG. 1 shows a part of a steering wheel with a superposition drive which comprises a locking device according to the invention;

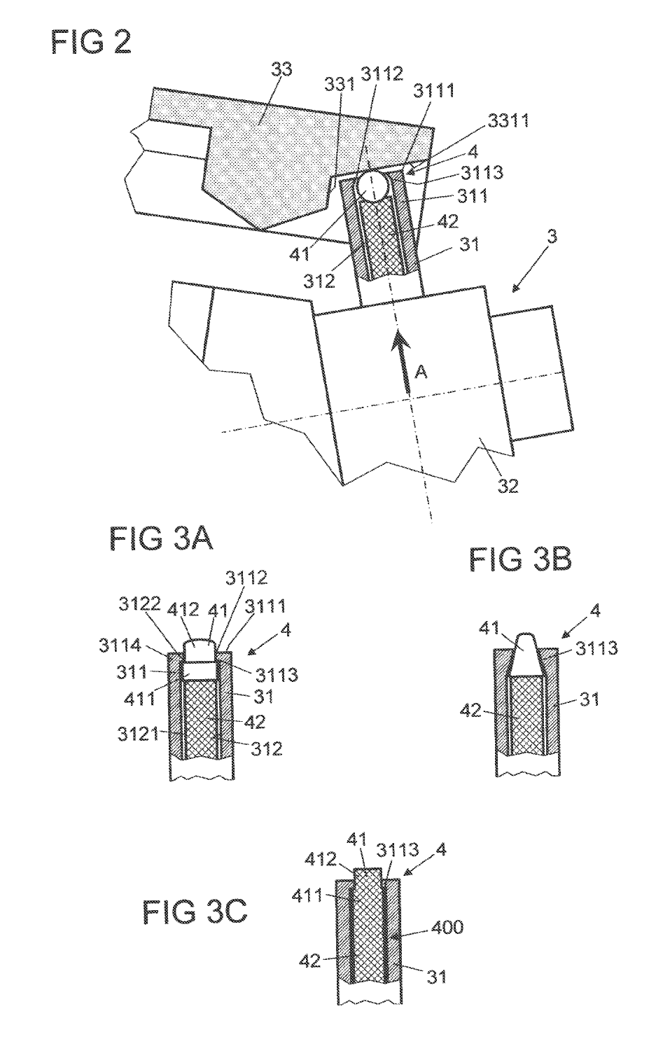

FIG. 2 shows an enlarged view of the locking device of FIG. 1; and

FIGS. 3A-C show various configurations of the damping mechanism of the locking device according to the invention.

FIG. 1 shows a section of a steering wheel 1 of a motor vehicle, in whose hub and/or spoke region (including three spokes 11) a superposition drive 2 is arranged, with which an additional steering angle can be imposed on a steering shaft of the vehicle, which is super-imposed on a steering angle introduced into the steering shaft by turning a steering wheel rim of the steering wheel.

The superposition drive 2 in particular is arranged on a side of the steering wheel 1 facing away from the driver and includes a drive worm 22 meshing with a worm gear 21. The worm gear 21 is coupled with the steering shaft of the vehicle via a tab 211 which protrudes from a housing 24 of the superposition drive 2, so that a rotary movement of the worm gear 21 is transmitted to the steering shaft. The drive of the drive worm 22 is effected via an actuator 23, which in particular is formed in the form of an electric motor. Possible configurations of further components of the superposition drive shown in FIG. 1 and its attachment to the steering wheel and with the steering shaft are described e.g. in the above-mentioned WO 2010/115707 A1.

The steering wheel 1 furthermore includes a locking device 3 according to the invention separate from the superposition drive 2, which serves to lock the superposition drive 2 by mechanical action; for example to ensure a safe introduction of a steering angle into the steering shaft by a torque applied by the driver via the steering wheel rim of the steering wheel in the case of a failure of the superposition drive or in its non-active condition.

The locking device 3 comprises a locking element in the form of a locking bolt 31, which via an (e.g. electromagne(ic) actuator is axially movable from a release position into the locking position shown in FIG. 1. This is accomplished e.g. by an interruption of the power supply (deactivation) to an electromagnet (not shown) of the actuator, whereby a holding force exerted on the locking bolt 31 is eliminated and the locking bolt 31 is transferred into the locking position under the influence of spring elements (not shown either). To again move the locking bolt 31 from the locking position into the release position, the holding force is built up again by energizing (activating) the electromagnet of the actuator, whereby the locking bolt 31 is brought into the release position by biasing the above-mentioned spring elements and is maintained in this release position.

The actuator of the locking device 3 and at least a section of the locking bolt 31 are located in the interior of a housing 32, wherein in the locking position a first end 311 (locking end) of the locking bolt 31 protrudes from an opening 3220 of the housing 32, wherein the opening 3220 of the housing 32 can serve as guide for the locking bolt 31.

The locking bolt 31 in particular is a one-piece element. It is, however, also possible that the locking bolt 31 comprises a first element, which forms the first free end 311, and a second element separate from the first element, at which a second end is formed, wherein the two elements are firmly connected with each other.

The housing 32 of the locking device 3 rests against a flange-like abutment portion 241 of the housing 24 of the superposition drive 2 and in particular is attached to the housing 24 (e.g. by means of suitable fastening elements, such as in the form of screws). In its locking position, the locking bolt 31 cooperates with a movable (rotatable) component of the superposition drive 2 in the form of a locking disk 33, wherein the locking disk 33 is non-rotatably coupled with a free end 221 of the drive worm 22 protruding from the housing 24 of the superposition drive 2. Along its outer circumference, the locking disk 33 also includes cutouts 331 into which the first free end 311 of the locking bolt 31 reaching out of the housing 32 of the locking device 3 engages and most of all positively locks the locking disk 33, so that the drive worm 22 coupled with the locking disk 33 also is blocked.

During the movement of the locking bolt 31 into the locking position, the first end 311 of the locking bolt 31 is brought in mechanical contact with the locking disk 33, i.e. a force is introduced into the locking bolt 31, which can lead to e.g. vibrations which propagate onto the steering wheel rim of the steering wheel, To suppress such vibrations and a noise development connected with the vibrations as far as possible, the steering wheel can include bearing means via which the locking device 3 is elastically mounted on the superposition drive 2. In this connection reference also is made e.g. to WO 2012/120079.

The cutouts 331 of the locking disk 33 extend from a side facing the locking bolt 31 only down to a specifiable depth, i.e. they do not extend completely through the locking disk 33, but each have a bottom 3311. During the movement of the locking bolt 31 into the locking position (along a locking direction A, see arrow in FIG. 2) a mechanical contact occurs of the front end 311 of the locking bolt 31 in particular with the bottom 3311 of the cutouts 331 in the locking disk 33 and as a result a development of noise. To suppress this noise development as far as possible, the locking device 3 includes a damping mechanism 4 which will be explained in detail below.

FIG. 2 shows an enlarged section of the locking device 3, wherein the end 311 of the locking bolt 31 protruding from the housing 32 of the locking device 3 is shown in a partly cut-away view. At least in its portion facing the locking disk 33, the locking bolt 31 is designed in the form of a sleeve. i.e. it includes an (in particular cylindrical) cavity 312, which in particular extends in longitudinal direction of the locking bolt 31.

As compared to a continuous design of the locking bolt (i.e. a design of the complete locking bolt of solid material), the sleeve-shaped locking bolt according to the invention has a lower mass, which reduces the impulse occurring on impingement of the locking bolt 31 onto the locking disk and thus in particular reduces the noise development on impingement of the locking bolt 31.

The damping mechanism 4 already referred to above comprises a contact element in the form of a spherical impact element 41, which is arranged in the cavity 312. A portion of the impact element 41 protrudes from an opening 3112 formed in an end face 3111 of the end 311 of the locking bolt 31. The portion of the impact element 41 protruding from the opening forms a curved contact surface with which the impact element 41 gets in mechanical contact with the locking disk 33 (in particular with the bottom 3311 of one of the cutouts 331), when the locking bolt 31 is moved into the locking position.

The damping mechanism 4 furthermore includes an elastic (e.g. formed of an elastomer) damping element 42 which on a side of the impact element 41 facing away from the opening 3112 is arranged in the cavity 312 of the locking bolt 31 and supports on an abutment (not shown) of the locking bolt 31, The abutment is formed e.g. by an inside located opposite the front end face 3111 along the longitudinal axis of the locking bolt 31, which faces the cavity 312, or forms a separate closure element arranged there.

The diameter of the opening 3112 formed in the end face 3111 of the locking bolt 31 is smaller than the diameter of the cavity 312, wherein the diameters are viewed in a plane vertical to the longitudinal axis of the locking bolt 31. In terms of its material properties and dimensions the damping element 42 is designed such that it presses the impact element 41 with a defined force in locking direction A against an inside 3113 of the end 311 defining the cavity 312 and holds it in contact with the inside 3113. The cavity 312 tapers towards the opening 3112, so that the inside 3113 extends obliquely to the axis of the locking bolt 31,

In addition, the measure by which the impact element 41 protrudes beyond the end face 3111 also can be determined by the diameter of the opening 3112.

During a locking movement of the locking bolt 31, the impact element 41 will first impinge on the locking disk 33. Due to the contact with the locking disk 33, the impact element 41 will then be moved into the cavity 312 of the locking bolt 31 against the restoring force of the damping element 42, i.e. there is a movement of the impact element 41 relative to the locking bolt 31. Due to this movement, the impact element 41 is removed from the opening 3112, i.e. from the inside 3113 of the end 311, so that the direct contact between the impact element 41 and the locking bolt 31 is interrupted. Since the impact element 41 is decoupled from the locking bolt 31, a transmission of an impact sound (i.e. vibrations of the impact element 41) produced on impingement of the impact element 41 to the locking bolt 31 by structure-borne sound transmission is counteracted. A reduction of the noise development can be realized already for this reason.

In addition, the locking bolt 31 is braked as smoothely as possible by the elasticity of the damping element 41. As a result, the front end face 3111 of the locking bolt 31 impinges on the locking disk 33 with reduced speed, which further reduces the noise development during the locking movement of the locking bolt 31. With a corresponding design of the damping arrangement (in particular of the contact element 31 and/or of the damping element 41) an impingement of the end face 3111 of the locking bolt 31 on the locking disk 33 also can be avoided completely.

FIGS. 3A and 3B show modifications of the damping mechanism 4. According to FIG. 3A the diameter of the cavity 312 does not decrease continuously, but abruptly, wherein the cavity 312 has a first portion 3121 which is adjoined by a second portion 3122 with smaller diameter. The second portion 3122 is formed in a jacket portion 3114 of the end 311 of the locking bolt 3 oriented transversely to the longitudinal axis of the locking bolt 31 and extends up to the opening 3112 which extends in the plane of the end face 3111 of the end 311. The opening 3112 thus has a diameter which is smaller than the diameter of the first portion 3121 of the cavity 312.

Correspondingly, the impact element 41 also includes a first portion 411 which has a larger diameter than a second portion 412, which as viewed in locking direction is located before the first portion 411. Before a contact of the locking bolt 31 with the locking disk 33, the first portion 411 of the damping element 42 thus presses the impact element 41 against the inside 3113 of the locking bolt 31 formed by the jacket portion 3114. The second portion 412 of the impact element 41 has a curved contact surface which comes to rest against the locking disk 33. The convexity of the contact surface, however, only is optional. It is also conceivable that the contact surface is flat and in particular extends substantially vertically to the longitudinal axis of the locking bolt 31.

According to FIG. 3B, the stopping element 41 is formed in the form of a truncated cone, wherein the inside 3113 of the locking bolt 31, against which the stopping element 41 is biased by means of the damping element 42, is formed complementary to the shell surface of the stopping element 41 and correspondingly is oriented obliquely to the longitudinal axis of the locking bolt 31.

It should be noted that the stopping element 41 and the damping element 42 can be formed of different materials, but can be firmly connected with each other. For example, the stopping element 41 and the damping element 42 are connected with each other by an adhesive connection or by vulcanizing, so that they form a unit.

FIG. 3C relates to a further embodiment of the damping mechanism 4 of the locking device 3 according to the invention. Accordingly, the stopping element 41 and the damping element 42 are formed integrally, i.e. the stopping element 41 and the damping element 42 are formed by portions of a part 400 which in particular is realized by a molded part, for example of a plastic material. In the variant shown in FIG. 3C, the cavity 312 of the locking bolt 31 is formed with a step analogous to FIG. 3A. Correspondingly, the portion of the part 400, which forms the stopping element 41, includes a rear portion 411 which has a larger diameter than a front portion 412 and which rests against the inside 3113 of the locking bolt 31. Of course, other types of stopping elements and/or damping elements also can be realized as portions of an integral part, e.g. the frustoconical stopping element shown in FIG. 3B.

In addition, it should be noted that the explained exemplary embodiments relate to a use of the locking device according to the invention for locking a superposition drive. It is, however, also possible to use the illustrated embodiments of the locking device for locking another moving component, which is not part of a superposition drive. In addition, it is also possible that the contact element (impact element) is not arranged in the interior of the locking element, but outside.

### LIST OF REFERENCE NUMERALS

1 steering wheel

2 superposition drive

3 locking device

4 damping mechanism

11 spoke

21 worm gear

22 drive worm

23 actuator

24 housing

31 locking bolt

32 housing

33 locking disk

41 impact element

42 damping element

211 tab

221 end

241 abutment portion

311 end of locking bolt

312 cavity

331 cutout

400 part

411 first portion

412 second portion

3111 end face

3112 opening

3113 inside

3114 jacket portion

3121 first portion of cavity

3122 second portion of cavity

3220 opening of housing

3311 bottom

1. A locking device for locking a movable component, in particular of a superposition drive, comprising
a locking element which in a locking position is formed to cooperate with the movable component, wherein
the locking element includes a damping mechanism which during the movement of the locking element into the locking position attenuates a mechanical contact of the locking element with the movable component, and wherein
the damping mechanism comprises an elastically mounted contact element movable relative to the locking element, which is arranged such that during the movement of the locking element into the locking position it gets in contact with the movable component.

2. The locking device according to claim 1, wherein the contact element is formed and arranged such that during the movement of the locking element into the locking position it gets in contact with the movable component before the locking element.

3. The locking device according to claim 1, wherein the contact element is sectionally arranged in a cavity of the locking element.

4. The locking device according to claim 3, wherein the locking element includes an opening to the cavity in an end to be arranged facing the movable component, from which opening the contact element protrudes before a contact with the movable element.

5. The locking device according to claim 1, wherein the damping mechanism includes an elastic damping element arranged in the cavity of the locking element, via which the contact element is elastically movably mounted.

6. The locking device according to claim 5, wherein the elastic damping element includes an elastic material or is formed of an elastic material.

7. The locking device according to claim 5, wherein the contact element and the damping element are separate parts.

8. The locking device according to claim 5, wherein the contact element is formed integrally with the damping element.

9. The locking device according to claim 4, wherein the damping mechanism includes an elastic damping element arranged in the cavity of the locking element, via which the contact element is elastically movably mounted, and wherein the damping element is arranged on a side of the contact element facing away from the opening.

10. The locking device according to claim 5, wherein under the influence of the damping element the contact element is biased against an inside of the locking element

11. The locking device according to claim 4, wherein the opening has a diameter which is smaller than the largest diameter of the contact element.

12. The locking device according to claim 4, wherein the diameter of the opening is smaller than the largest diameter of the cavity.

13. The locking device according claim 4, wherein the diameter of the cavity decreases towards the opening.

14. The locking device according to claim 1, wherein the contact element has a curved contact surface via which it comes to rest against the movable component.

15. A superposition drive for a motor vehicle with a locking device according claim 1.
